(19) United States
(12) Patent Application Publication
(10) Pub. No.: US 2003/0193593 A1
(43) Pub. Date: Oct. 16, 2003

(54) X-y addressable CMOS APS with compact pixel pitch

(75) Inventors: Paul P. Lee, Pittsford, NY (US); Robert M. Guidash, Rochester, NY (US); Timothy J. Kenney, Pittsford, NY (US); Teh-Hsuang Lee, Carlsbad, CA (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/454,584

(22) Filed: Jun. 5, 2003

Related U.S. Application Data
(63) Continuation-in-part of application No. 08/821,988, filed on Mar. 21, 1997.
(60) Provisional application No. 60/018,128, filed on May 22, 1996.

(51) Int. Cl. H04N 5/335

(52) U.S. Cl. 348/302

(57) ABSTRACT

An X-Y addressable active pixel sensor that uses serial shift registers to select image windows resulting in less semiconductor area being employed compared with prior art address decoding techniques comprising: an X-Y addressable imager having signal lines in both X and Y directions; at least one pair of serial shift registers operatively connected to the X-Y imager such that there is at least one serial shift register in each x and y directions to select signal lines to be applied to the X-Y imager; and loading circuitry that provides the capability for selectively addressing imaging sub-windows by placing bit patterns into the shift registers.

### CROSS-REFERENCE TO RELATED APPLICATIONS

This is a continuation-in-part of application Ser. No. 08/821,988, filed Mar. 21, 1997, entitled AN X-Y ADDRESSABLE CMOS APS WITH COMPACT PIXEL PITCH.

### FIELD OF INVENTION

The present invention relates generally to the operation of an active pixel sensor and more specifically to an x-y addressable feature of such a sensor that allows each and every one of the pixels in the array to be selected and read out singly or in groups.

### BACKGROUND OF THE INVENTION

In an x-y addressable image such as an active pixel sensor (APS), the conventional method of selecting pixels to be read out is by employing a full address decoding circuit which translates the binary encoded addresses into the specific x-y signaling lines. By changing the addresses in a pre-determined fashion, any arbitrary rectangular window, or single pixel can be selected for output. This method requires a decoder for each of the x and y signaling lines and therefore requires packing the circuit to fit the pixel pitch of the imager.

A simpler method of generating x-y addresses is to use serial shift registers instead of address decoders. The serial shift register design is simpler to implement and allows smaller spacing between pixels, but is not capable of performing the sub-windowing function.

It should be apparent from the foregoing discussion that there remains a need in the art for an x-y addressable pixel sensor that allows smaller spacing between pixels as well as for retaining the capability of sub-windowing.

### SUMMARY OF THE INVENTION

The present invention overcomes the previously discussed shortcomings within the prior art by using additional circuits to pre-load the shift registers so that read-out of the sub-windows can be accomplished. The result is that the present invention provides x-y addressable features to active pixel sensors (APS) that allow each and every one of the pixels in the array to be selected and read out singly or in groups. This feature allows the readout of the image sensor in sub-window format where the array of pixels read out can be programmed to be a portion of the total imager. The sub-window format allows trading off the number of pixels per image output (resolution) with the frame rate of the read out and also enables electronic zoom and pan operations.

Advantageous Effect of the Invention

By using serial shift registers to select the signaling lines both in x and y directions, the per row and per column circuit required is simplified from a full address decoder which takes up more area to shift register design. This allows shrinking the pixel size of the imager to a smaller dimension. For example, the conventional APS pixel design is 20 times the smallest allowed line length of the integrated circuit fabrication technology. This 20× limit is due to the size of the address decoder. By using the serial shift register integration, this limit can be reduced from between 7 to 15 times the size of the line length. Therefore, the overall size of the imager can be reduced by 24% to 67% without using higher cost smaller geometry fabrication technology. The present invention maintains the important feature of sub-windowing when the shift register design is used to achieve smaller pixel and therefore smaller die-size.

### BRIEF DESCRIPTION OF THE DRAWINGS

FIG. 1 is a prior art conventional x-y addressable imager;

FIG. 2 is an x-y addressable imager employing shift registers as envisioned by the present invention;

FIG. 3 is another x-y addressable imager embodiment of the present invention employing shift registers; and

FIG. 4 illustrates detailed operation of the present invention.

To facilitate understanding, identical reference numerals have been used, where possible, to designate identical elements that are common to the figures.

### DETAILED DESCRIPTION OF THE INVENTION

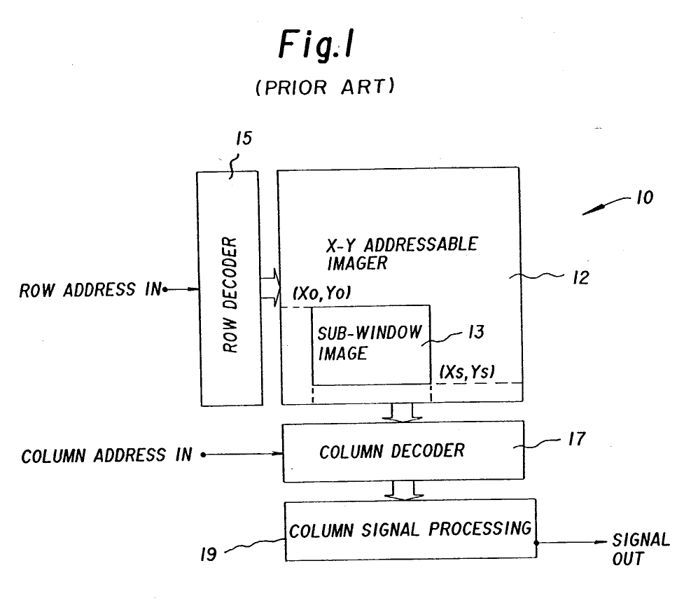

FIG. 1 shows a prior art conventional x-y addressable imager, generally referred to as 10, having x-y addressable imager 12 with a contained sub-window image 13 within imager 12, row decoder 15, column decoder 17, and column signal processing 19.

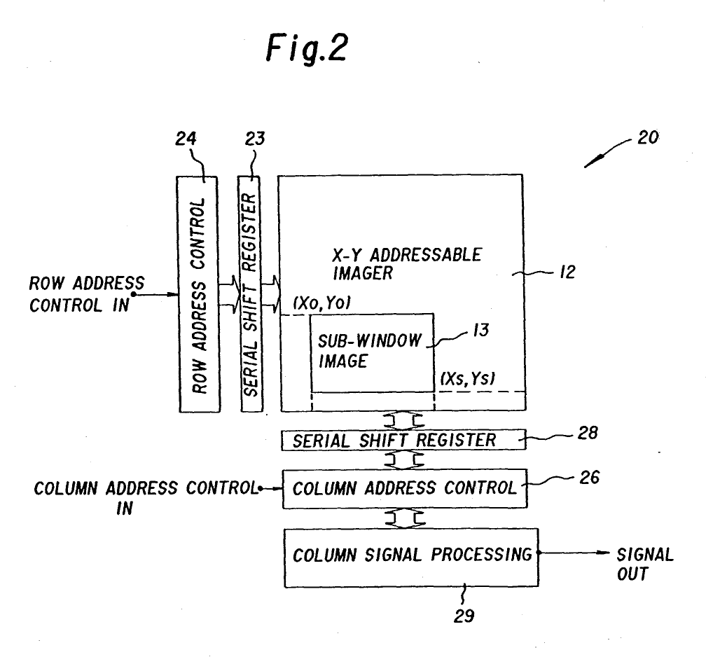

FIG. 2 illustrates a sensor 20 as envisioned by the present invention having x-y addressable imager 12 with sub-window image 13. The additional circuits added to the x and the y signaling control are shift registers 23, 28. The shift registers 23, 28 are used to interface the row address 24 and the column address 26, respectively, to the imager. The shift registers 23, 28 allow for a pre-determined starting location of each shift register to be loaded with a digital “1” to select the starting x-y location. The shift register then subsequently scans through a pre-determined number of locations to select the size of the sub-window to be read out through the column signal processing circuit 29. The added circuit controls the shifting of the digital “1” so that the scans in x and y are repeated for subsequent output frames. Since only one scanning control circuit is required for each of the x and y dimension, the pixel pitch can remain at the smaller size achieved using the shift registers.

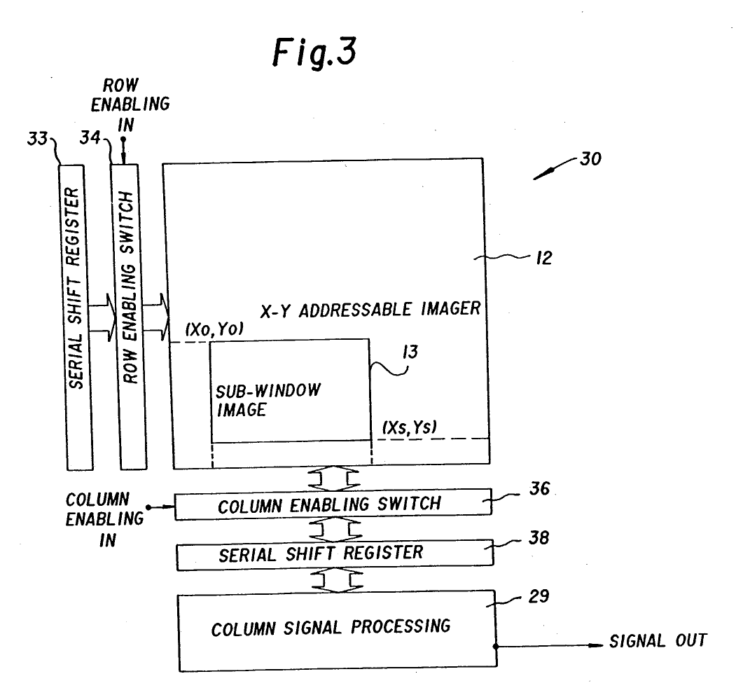

An alternate embodiment of the present invention is shown in FIG. 3, generally indicated as 30. In the alternate embodiment shown in FIG. 3, switch-enabling circuits 34, 36 are used in place of scanning control circuits to allow only a pre-determined sub-window 13 to be read out through column signal processing circuit 29. The switch enabling circuits are set up by loading a pre-determined sequence of digital “1's” on the rows and columns of interest, from the row and column serial shift registers, 33 and 38 respectively, only this portion of the imager is output. The drawback of this approach is that since all the pixels are scanned by the shift registers, there is no effective change in the frame rates of the readout.

Employing serial shift registers to select the signaling lines in both x and y directions simplifies the per row and per column circuit required compared to a full address decoder which takes up more area. This allows shrinking the pixel size of the imager to a smaller dimension. For example, the conventional APS pixel design is 20 times the smallest allowed line length of the integrated circuit fabrication technology. This 20 times limit is due to the size of the address decoder. By using the serial shift register integration, this limit can be reduced from between 7 to 15 times the size of the line length. Therefore, the overall size of the imager can be reduced by 25% to 67% without using higher cost smaller geometry fabrication technology. The present invention maintains the important features of sub-windowing when the shift register design is used to achieve smaller pixel and therefore smaller die-size.

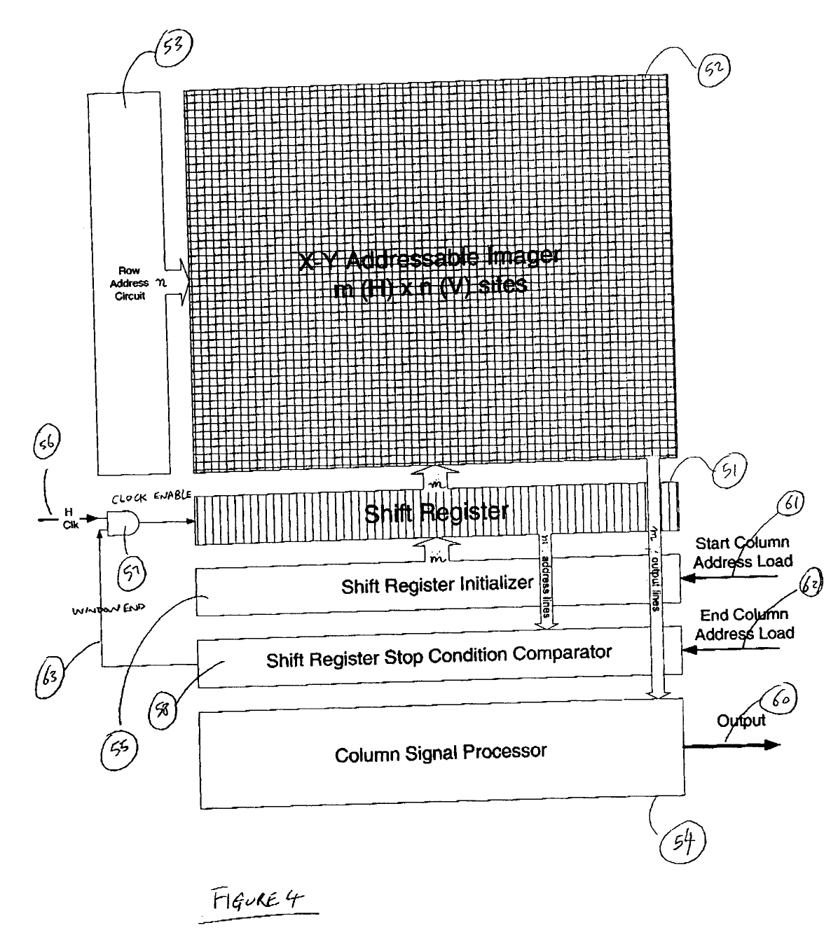

Detailed operation of the present invention is further exemplified in FIG. 4. A shift register 51 is shown connected to a whole or a portion of a x-y addressable imager 52 having m (x direction) by n (y direction) imaging sites. For simplicity sake, only the columns (x) addressing is shown. This same column addressing scheme is applicable to the row (y) addressing circuit 53. Only a single output from the column signal processor 54 is shown. Multiple outputs would require replication of the shift register scheme for multiple sets of the columns in the x-y addressable imager. In its simplest operation, the shift register 51 selects a single column at any one instance of time by having a logical 1 in one of its locations (starting from the first location furthest to the left) and in coincidence with a specific row address, selects a single pixel to be processed by the column signal processor 54 to have its light sensing output 60. The column address is sequenced by propagating this logical 1 in one direction (for example to the right).

In order to select a sub-window to be read out of this portion of the x-y addressable imager, prior art teaches skipping columns by the use of counters to keep track of the start and stop column counts, hierarchical (block addressing) shift registers with one enabling a block of columns and then individual column within the selected block is selected by another shift register. In the first method, a latency is incurred while the shift register clocks through the columns but the selection is disabled. In the second method, multiple shift registers are needed. In this invention, a single shift register is employed and no there is no latency. Output is enabled immediately on the first clock signal. This is accomplished by pre-loading (programming in real time by a user) a logical 1 into the selected start column by the use of circuitry in the shift register initializer 55 under the control signals of start column address load 61 (from a micro-controller or hard-wired logic). Subsequent columns are selected and read out by shifting this logical 1 to the right at each clock signal 56. This clock signal is gated by the clock enable circuit (shown as an AND gate) 57. The clock is allowed to effect the shifting of the logical 1 in the shift register at the start of each frame. The image sub-window size to be read out is controlled by the location of the last column. A shift register stop condition comparator circuit 58 which compares the location of the shift register logical one and the pre-determined location is used to disable the shift register clock by presenting a logical 0 in the window end signal 63 which is decoded from the command end column address load 62.

The invention has been described with reference to a preferred embodiment. However, it will be appreciated that variations and modifications can be effected by a person of ordinary skill in the art without departing from the scope of the invention.

PARTS LIST:

10 x-y addressable imager

12 x-y addressable imager

13 sub-window image

15 row decoder

17 column decoder

19 column signal processing

20 sensor

23 shift register

24 row address

26 column address

28 shift register

29 column signal processing circuit

30 alternate embodiment

33 row serial shift register

34 row (switch) enabling circuits

36 column (switch) enabling circuits

38 column serial shift register

51 shift register

52 x-y addressable imager

53 row addressing circuit

54 column signal processor

55 shift register initializer

56 clock signal

57 clock enable circuit

58 shift register stop condition comparator circuit

60 light sensing output

61 start column address load

62 command end column address load

63 window end signal

What is claimed is:

1. An active pixel sensor that is X-Y addressable comprising:
an X-Y addressable imager arranged in a series of rows and columns having signal lines in both first and second directions for enabling readout of selected rows and columns;
only one pair of serial shift registers operatively connected to the X-Y imager;
only one serial shift register in the first direction and only one serial shift register in the second direction to select signal lines to be applied to the X-Y imager;
means for reading out selected locations from the X-Y addressable imager; and
a loading mechanism operatively coupled to the shift registers that is capable of placing programmable, real-time, user-defined bit patterns into the shift registers that identify any individual selected row and column by placement of a pair of start addresses to a subset of the X-Y addressable imager and subsequently causes the shift registers to scan only and directly through any individual selected row and column for skipping the non-selected rows and columns; wherein the shift register starts and stops on any individual selected row and column in which output is enabled at the first clock cycle of the shift register in the first direction without waiting for an enable signal to propagate through non-selected columns.

2. The sensor of claim 1 wherein the loading mechanism further comprises a pair of address control circuit such that there is at least one address control circuit for each of the first and second directions.

3. The sensor of claim 2 wherein the address control circuits further comprises means for placing a binary one into the serial shift registers at predetermined locations.

4. The sensor of claim 2 wherein the address control circuits further comprises means for placing a binary bit into the serial shift registers.

5. The sensor of claim 1 further comprising an enabling mechanism between at least one of the shift registers and the x-y imager.

6. A method of making an active pixel sensor that is X-Y addressable comprising the steps of:
providing an X-Y addressable imager in a series of rows and columns having signal lines in both first and second directions for enabling readout of selected rows and columns;
providing only one pair of serial shift registers operatively connected to the X-Y imager;
providing only one serial shift register in the first direction and only one in the second direction to select signal lines to be applied to the X-Y imager and means for reading out selected location from the X-Y imager; and
providing registers and control circuits for placing arbitrary, realtime, user-defined bit patterns into the shift registers that identify a pair of initial addresses for any individual selected row and column of a subset of the X-Y addressable imager exclusive of addresses that are not in the subset and for subsequently causing the shift register to scan only and directly through any individual selected row and column for skipping the non-selected rows and columns; wherein the shift register starts and stops on any individual selected row and column in which output is enabled at the first clock cycle of the shift register in the first direction without waiting for an enable signal to propagate through non-selected columns.

7. The method of claim 6 wherein the step of providing registers and control circuits comprises providing at least a pair of address control circuit such that there is at least one address control circuit for each of the first and second directions.

8. The method of claim 7 wherein the step of providing at least a pair of address control circuits further comprises providing means for placing a binary one into the serial shift registers at predetermined locations.

9. The method of claim 7 wherein the step of thirdly providing address control circuits further comprises providing means for placing a binary bit into the serial shift registers.

10. The method of claim 6 further comprising the step of providing an enabling mechanism between at least one of the shift registers and the x-y imager.
